(19) United States
(12) Patent Application Publication
(10) Pub. No.: US 2010/0084358 A1
(43) Pub. Date: Apr. 8, 2010

(54) JIB BOOM ROTATING TOWER CRANE

(75) Inventors: Thomas Herse, Bad Rappenau (DE); Ulrich Dörzbach, Heilbronn (DE)

Correspondence Address: FOLEY AND LARDNER LLP;SUITE 500, 3000 K STREET NW, WASHINGTON, DC, 20007, US

(73) Assignee: Wolffkran AG

(21) Appl. No.: 12/528,049

(22) PCT Filed: Feb. 14, 2008
(86) PCT No.: PCT/EP2008/001118

§ 371 Date: Dec. 3, 2009

(30) Foreign Application Priority Data
Feb. 23, 2007 (DE) 10 2007 009 402.9

(51) Int. Cl. B66C 23/26

(52) U.S. Cl. 212/237

(57) ABSTRACT

The invention relates to a jib boom rotating tower crane, wherein the counterweight/pinnacle system is divided into three trellises, a rotating frame trellis, a counterweight trellis, and a pinnacle trellis, wherein the counterweight trellis has a common side with each of the pinnacle trellis and the rotating frame trellis. The pinnacle trellis preferably comprises a beam to which a pulley block with a reeved lull cable can be attached.

This invention relates to a jib boom rotating tower crane, the counterweight pinnacle system of which is divided into trellises.

Tower cranes comprise a crane base from which a tower extends upward. Attached to an upper segment of the tower is a boom and possibly a counterweight. Tower cranes of the prior art are described, for example, in DE 35 10 116 C2. On jib boom rotating tower cranes in which the top portion of the crane rotates, a rotating frame is attached to the upper end of the tower. Located above the rotating frame is a counterweight pinnacle system with which a boom is connected, the angle of which with respect to the horizontal plane is variable. In one form of construction of the jib boom rotating tower crane described above, the angle of the boom with respect to the horizontal plane is determined by a luff cable, the length of which can be set by means of a cable luffing gear.

EP 0 298 391 B1 describes a jib boom rotating tower crane, the top portion of which rotates, and which has a pinnacle that is realized in the form of a transport and assembly module. One disadvantage of this solution is that this pinnacle is a very heavy component, the size and weight of which present problems during transport, erection and dismantling of the crane. The size of the pinnacle also requires extreme precision in the construction of the counterweight pinnacle system, because even the smallest discrepancies are very difficult, time-consuming and expensive to correct.

The object of the invention is to make available a jib boom rotating tower crane, the top portion of which rotates and the counterweight pinnacle system of which eliminates the above mentioned disadvantages of the counterweight pinnacle systems of the prior art.

The invention teaches that the counterweight pinnacle system is divided into three trellises with the characteristics described in Claim 1. Additional embodiments of the invention are the objects of the dependent claims or are described below.

The division of the counterweight pinnacle system into trellises claimed by the invention results in components that are significantly lighter in weight than those described in EP 0 298 391 B1. The connections between the beams that form the trellises can be realized so that they are articulated or flexible, as a result of which larger tolerances are possible during assembly. The fabrication costs are lower because the trellises can be manufactured from prefabricated structural shapes, which means that less welding work is necessary.

The invention is particularly advantageous when the jib boom rotating tower crane in question is a crane in which the angle of the boom with respect to the horizontal plane is determined by a luff cable, the length of which can be set by means of a cable luffing gear.

In one particularly advantageous embodiment of the invention, the cable luffing gear is fastened to an element (beam) of the pinnacle trellis, and when the cable is reeved, a pulley block can be detached from the main guy of the boom, and is connected firmly but detachably with the beam for the transport of this element (beam) of the pinnacle trellis. This feature has the advantage that this element of the pinnacle trellis can be realized in the form of a transport and assembly module, so that a manual cable reeving is no longer necessary during the assembly and erection of the crane at the construction site.

One exemplary embodiment of the invention is explained in greater detail below and is illustrated in the accompanying drawings, in which:

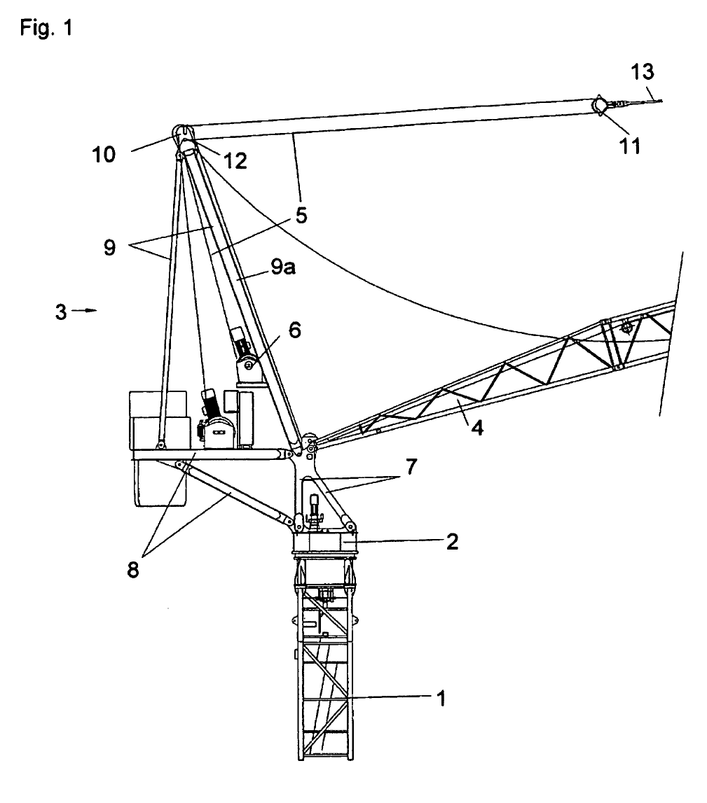

FIG. 1 shows the counterweight pinnacle system of a jib boom rotating tower crane claimed by the invention, and

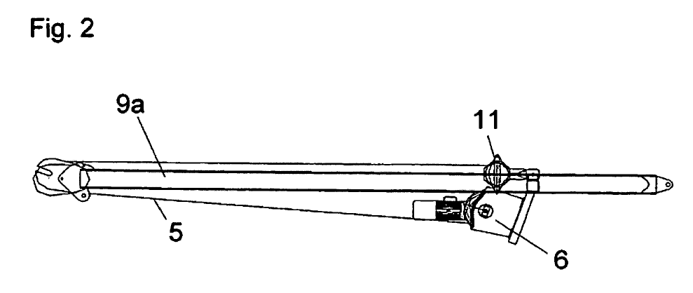

FIG. 2 shows a beam that belongs to the pinnacle trellis in the transport position.

FIG. 1 shows a portion of the upper area of a jib boom rotating tower crane claimed by the invention in two different boom positions. A rotating frame 2 is located on the upper end of the tower 1. Above the rotating frame 2 is the counterweight pinnacle system 3, with which the boom 4 is connected, and the angle of which with respect to the horizontal plane is determined by a luff cable 5, the length of which can be set by means of a cable luffing gear 6. The counterweight pinnacle system 3 is divided into a rotating frame trellis 7, a counterweight trellis 8 and a pinnacle trellis 9, each of which has three sides when viewed in perspective from the side. The rotating frame trellis 7 is below the boom, i.e. below the point at which the boom 4 is connected with the counterweight pinnacle system 3. The rotating frame trellis 7 is placed with its underside in a horizontal plane above the horizontal rotating frame 2. The counterweight trellis 8 has a side in common with each of the pinnacle trellis 9 and the rotating frame trellis 7. The luff cable 5 is guided with multiple cable reeving by means of pulleys 10 at the top of the beam 9a that belongs to the pinnacle trellis 9 and via the pulley block 11 to a fixed point 12 on the top of the beam 9a. The pulleys 10 and the cable luffing gear 6 are connected with the beam 9a both during transport and in the operating position. During transport, the pulley block 11 is fixed in position on the beam 9a. In the operating position of the crane after it has been erected at the construction site, the pulley block 11, after it has been detached from the beam 9a, is connected with the main guy 13 of the boom 4.

In FIG. 2, the beam 9a which is part of the pinnacle trellis is shown in the transport position. Both the cable luffing gear 6 and the pulley block 11 are fastened to the beam 9a.

1. Jib boom rotating tower crane comprising a tower, a rotating fame attached to the upper end of the tower and a counterweight pinnacle system located above the rotating frame, with which a boom is connected, the angle of which with respect to the horizontal plane is variable, characterized in that
the counterweight pinnacle system is divided into three trellises: a rotating frame trellis, a counterweight trellis and a pinnacle trellis, whereby the counterweight trellis has a side in common with each of the pinnacle trellis and the rotating frame trellis.

2. Jib boom rotating tower crane as recited in claim 1, characterized in that the angle of the boom with respect to the horizontal plane is determined by a luff cable, the length of which can be set by means of a cable luffing gear.

3. Jib boom rotating tower crane as recited in claim 2, characterized in that the pinnacle trellis comprises a beam on which the cable luffing gear is fastened, and that when the luff cable is reeved, a pulley block can be detached from the main guy of the boom and connected with the beam.
